(19) United States
(12) Patent Application Publication
(10) Pub. No.: US 2007/0038418 A1
(43) Pub. Date: Feb. 15, 2007

(54) Method and apparatus for modeling multivariate parameters having constants and same pattern and method of fabricating semiconductor using the same

(75) Inventors: Byung-Bok Ahn, Hwaseong-si (KR); Tae-Jin Yun, Suwon-si (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 11/500,987

(22) Filed: Aug. 9, 2006

(30) Foreign Application Priority Data
Aug. 12, 2005 (KR) 10-2005-0074484

(51) Int. Cl. G06F 17/10

(52) U.S. Cl. 703/2

(57) ABSTRACT

Example embodiments of the present invention relate to a multivariate modeling method, a method of fabricating semiconductors using a semiconductor fabricating facility and a multivariate model creating apparatus. Other example embodiments of the present invention relate to a method and apparatus for modeling multivariate parameters having constants and the same pattern and a semiconductor fabricating method of detecting whether a semiconductor fabricating facility is operating normally using the multivariate modeling method. In a multivariate modeling method according to example embodiments of the present invention, data of parameters are selected during a modeling period. Averages and standard deviations of the data of the parameters may be calculated. It may be determined whether the data of the parameters contain non-random data. If the data of the parameters do not contain non-random data, the data may be normalized using the averages and standard deviations of the data of the parameters. If the data of the parameters contain non-random data, random data may be added to data of a parameter containing the constants or the data similar to constants among the parameters. The data may be normalized by calculating an artificial standard deviation of the random data added data of the parameter. Characteristic values of the parameters may be analyzed from the normalized data. A model may be created based on the characteristic values.

### PRIORITY STATEMENT

This application claims priority under 35 U.S.C. § 119 to Korean Patent Application No. 10-2005-0074484, filed on Aug. 12, 2005, in the Korean Intellectual Property Office (KIPO), the entire contents of which are incorporated herein by reference.

### BACKGROUND

1. Field

Example embodiments of the present invention relate to a multivariate modeling method, a method of fabricating semiconductors using a semiconductor fabricating facility and a multivariate model creating apparatus. Other example embodiments of the present invention relate to a method and apparatus for modeling multivariate parameters having constants and the same pattern and a semiconductor fabricating method of detecting whether a semiconductor fabricating facility is operating normally using the multivariate modeling method.

2. Description of the Related Art

Statistical analysis is a process for obtaining valid information by measuring various characteristics of specific subjects of interest. Multivariate data analysis is a statistical technique for simultaneously analyzing measurement values or data of various phenomena or events. Through multivariate data analysis, more information may be obtained by simultaneously considering correlations and casualties of various variables measured through a questionnaire research or experiments and clarifying their effects. Multivariate data analysis is used as a statistical technique for describing and predicting various and complicated phenomena in the fields of economics, marketing, financing, and social/behavioral science. In contrast to univariate data analysis, multivariate data analysis is a statistical method for simultaneously considering correlations of various variables and clarifying their effects, by which a plurality of independent variables and a plurality of dependent variables may be analyzed at once. A multivariate data analysis method may include a principal component analysis (PCA) method, an independent component analysis (ICA) method, a partial least squares (PLS) method, and/or any other suitable method. If constants, data close to constants, or data having the same pattern are sampled during a modeling period, it may be difficult to perform multivariate modeling.

FIG. 1 is a flowchart of a conventional multivariate modeling method. Referring to FIG. 1, in S101, parameters for creating a multivariate model may be set and data of the set parameters may be selected. For example, three parameters P1, P2, and P3 may be selected and N data X11 to X1n, X21 to X2n, and X31 to X3n of the parameters P1, P2, and P3 may be selected. FIG. 2A illustrates a matrix representing the parameters P1, P2, and P3 and the selected data D1 to DN. In S102, basic statistical values may be obtained by calculating an average (Avg) and/or a standard deviation (Std) of the data of each of the parameters P1, P2, and P3. FIG. 2B illustrates a matrix representing the averages (Avg) and the standard deviations (Std) of the parameters P1, P2, and P3. Parameter P1 may have an average (Avg) of x1 and a standard deviation (Std) of x1 STD, parameter P2 may have an average (Avg) of x2 and a standard deviation (Std) of x2STD, and parameter P3 may have an average (Avg) of x3 and a standard deviation (Std) of x3STD.

In S103, the data of the parameters P1, P2, and P3 may be normalized. Normalization may be performed by obtaining a difference between a current value and an average value and dividing the obtained difference by a standard deviation. FIG. 2C illustrates a matrix representing normalized data of the parameters P1, P2, and P3. The parameters P1, P2, and P3 may have N normalized data Z11 to Z1n, Z21 to Z2n, and Z31 to Z3n. Correlations of the parameters P1, P2, and P3 may be derived using the normalized data Z11 to Z1n, Z21 to Z2n, and Z31 to Z3n of the parameters P1, P2, and P3. That is, a covariance matrix may be obtained using the normalized data Z11 to Z1n, Z21 to Z2n, and Z31 to Z3n of the parameters P1, P2, and P3, and an Eigen matrix, an Eigen value, and an Eigen transpose matrix may be derived from the covariance matrix. FIG. 2D illustrates a covariance matrix, an Eigen matrix, an Eigen value, and an Eigen transpose matrix, which may be obtained from the covariance matrix.

Conventional multivariate modeling methods maybe used in various fields, for example, semiconductor manufacturing, image processing, fingerprint recognition, face recognition, and/or the like. However, when data having singular values, for example, constants, or data very close to constants, exist in at least one of a plurality of parameters during a modeling period, or when parameters having data of the same pattern exist during a modeling period, multivariate modeling may not be performed. For example, referring to FIG. 3A, parameter P5 of five parameters P1 to P5 sampled during a modeling period may be considered as a constant parameter with no variation during the modeling period. Thus, model information illustrated in FIG. 3B may be obtained as basic statistical values of parameters P1 to P5 including parameter P5 having constant data. That is, if the constant parameter P5 with no variation of data values exists during the modeling period, because a standard deviation std5 of parameter P5 is about 0, it may be difficult to normalize data of the parameters P1 to P5, thereby making the modeling difficult.

When two parameters P2 and P3 of the five parameters P1 to P5 have the same pattern as illustrated in FIG. 4A, the variation between the parameters P2 and P3 may be the same. As such, when parameters having the same pattern are normalized, the same vectors may be obtained. Thus, as illustrated in the model information of FIG. 4B, parameter P3 of parameters P2 and P3 having the same pattern may not be applied to the multivariate modeling. Accordingly, an inverse matrix may not be obtained, and thus, an exact model may not be created in a multivariate data analysis method, for example, a PCA method, an ICA method, a PLS method, and/or the like. In this case, a method of performing multivariate modeling by removing one of parameters P2 and P3 having the same pattern, for instance, parameter P3, and normalizing the remaining parameters has been suggested. However, when multivariate modeling is performed by removing one of two or more parameters having the same pattern, correct modeling may not be achieved. For example, when failure of a semiconductor device in a semiconductor fabricating process is detected using a method of performing multivariate modeling without one of the parameters having the same pattern, if the failure related to the removed parameter is generated, it may be difficult to recover the failure.

### SUMMARY

Example embodiments of the present invention relate to a multivariate modeling method, a method of fabricating semiconductors using a semiconductor fabricating facility and a multivariate model creating apparatus. Other example embodiments of the present invention relate to a method and apparatus for modeling multivariate parameters having constants and the same pattern and a semiconductor fabricating method of detecting whether a semiconductor fabricating facility is operating normally using the multivariate modeling method.

Example embodiments of the present invention provide a method of performing multivariate modeling by adding random data to a parameter having substantially similar, or non-random, data (e.g., constants, data close to constants, or data having the same pattern).

Example embodiments of the present invention also provide a method of performing multivariate modeling by adding random numbers to an arbitrary parameter among parameters having non-random data.

Example embodiments of the present invention also provide a semiconductor fabricating method in which a normal operation of a semiconductor fabricating facility may be detected.

According to example embodiments of the present invention, there is provided a multivariate modeling method including selecting data of parameters during a modeling period, calculating averages and standard deviations of the data of the parameters and determining whether the data of the parameters contain non-random data (e.g., constants or data similar to constants). If the data of the parameters do not contain non-random data (e.g., constants or data similar to constants), the data may be normalized using the averages and standard deviations of the data of the parameters. If the data of the parameters contain non-random data (e.g., constants or data similar to constants), random data may be added to data of a parameter containing non-random data (e.g., constants or data similar to constants) among the parameters. The random data may have a value of an average about ±0.1% of the data of the parameters. The data may be normalized by calculating an artificial standard deviation of the added random data of the parameter. Characteristic values of the parameters may be analyzed from the normalized data and a model may be created based on the characteristic values. The constant data may have constant values without variation and the data similar to constants may have constant values without variation during the modeling period. It may be determined if the data of the parameters contains non-random data (e.g., constants or data similar to constants) by determining whether each standard deviation of the data of the parameters is about 0.

According to other example embodiments of the present invention, there is provided a multivariate modeling method including data of parameters that may be selected during a modeling period, averages and standard deviations of the data of the parameters may be calculated, the data may be normalized using the averages and the standard deviations of the data of the parameters, characteristic values of the parameters may be analyzed from the normalized data of the parameters and it may be determined whether parameters having non-random data exist using the characteristic values of the parameters. It also may be determined if the parameters may have non-random data by determining whether any eigen vector of the data of the parameters is about 0. If non-random data do not exist, a model may be created based on the characteristic values of the parameters. If non-random data does exist, random data may be added to an arbitrary parameter of the parameters having non-random data. The random data may have a value of an average about ±0.1% of the data of the parameters. The data may be normalized by calculating an artificial standard deviation of the random data added to the data of the parameter. Characteristic values of the parameters may be analyzed from the data normalized using the artificial standard deviation and a model may be created based on the characteristic values of the parameters.

According to other example embodiments of the present invention, there is provided a multivariate model creating apparatus including a data extraction unit selecting data of parameters and calculating averages and standard deviations of the selected data, a data normalization unit normalizing the data of the parameters using the averages and the standard deviations provided by the data extraction unit, a data analysis unit analyzing characteristic values of the parameters using the normalized data provided by the data normalization unit, a model creation unit creating a model based on the characteristic values of the parameters analyzed by the data analysis unit, a data determination unit determining whether each parameter contains non-random data (e.g., constant data) using the standard deviations calculated by the data extraction unit or whether parameters contains non-random data (e.g., data having the same pattern) using eigen vectors provided by the data analysis unit and a filter providing random data to the data extraction unit if it may be determined by the data determination unit that the parameters contain non-random data (e.g., constants or data similar to constants or may have the same pattern).

### BRIEF DESCRIPTION OF THE DRAWINGS

Example embodiments of the present invention will be more clearly understood from the following detailed description taken in conjunction with the accompanying drawings. FIGS. 1-11 represent non-limiting, example embodiments of the present invention as described herein.

FIG. 1 is a flowchart illustrating a conventional multivariate modeling method;

FIGS. 2A to 2D are tables illustrating matrices of data obtained using a conventional multivariate modeling method;

FIG. 3A is a diagram illustrating a parameter containing constant data in a conventional multivariate modeling method;

FIG. 3B is a table illustrating model information of parameters illustrated in FIG. 3A;

FIG. 4A is a diagram illustrating parameters having the same pattern in a conventional multivariate modeling method;

FIG. 4B is a table illustrating model information of parameters illustrated in FIG. 4A;

FIG. 5 is a flowchart illustrating a multivariate modeling method for parameters containing constant data according to example embodiments of the present invention;

FIGS. 6A to 6D are tables illustrating matrices of data obtained using the multivariate modeling method according to example embodiments of the present invention;

FIG. 7A-7B are diagrams illustrating a parameter containing non-random data in the multivariate modeling method according to example embodiments of the present invention;

FIG. 7C is a table illustrating model information of parameters illustrated in FIG. 7B;

FIG. 8 is a flowchart illustrating a multivariate modeling method for parameters containing constant data according to example embodiments of the present invention;

FIG. 9A is a diagram illustrating parameters having data of the same pattern in the multivariate modeling method according to example embodiments of the present invention;

FIG. 9B is a diagram illustrating a parameter to which random data may be added in the multivariate modeling method according to example embodiments of the present invention;

FIG. 9C is a table illustrating model information of parameters illustrated in FIG. 9B;

FIG. 10 is a flowchart illustrating a multivariate modeling method according to example embodiments of the present invention; and

FIG. 11 is a block diagram illustrating a multivariate model creating apparatus for implementing a multivariate modeling method according to example embodiments of the present invention.

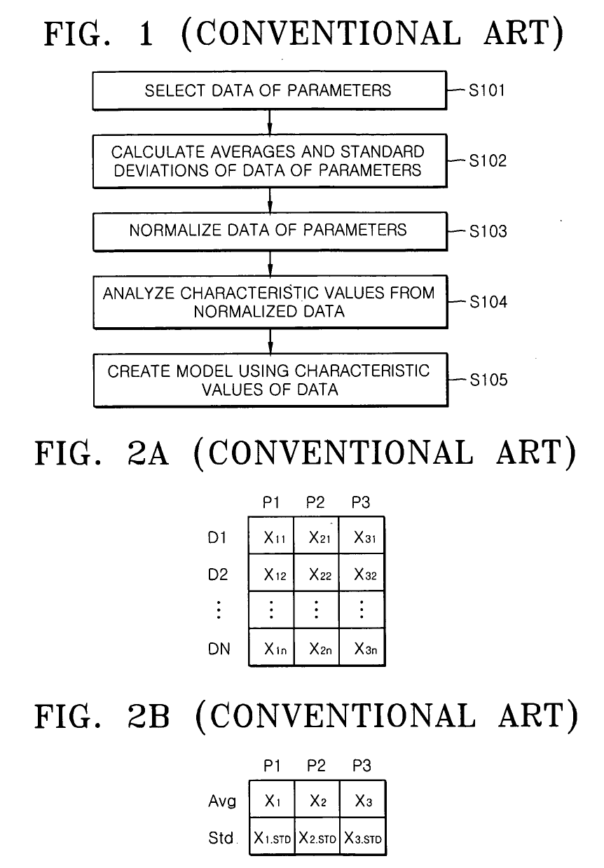

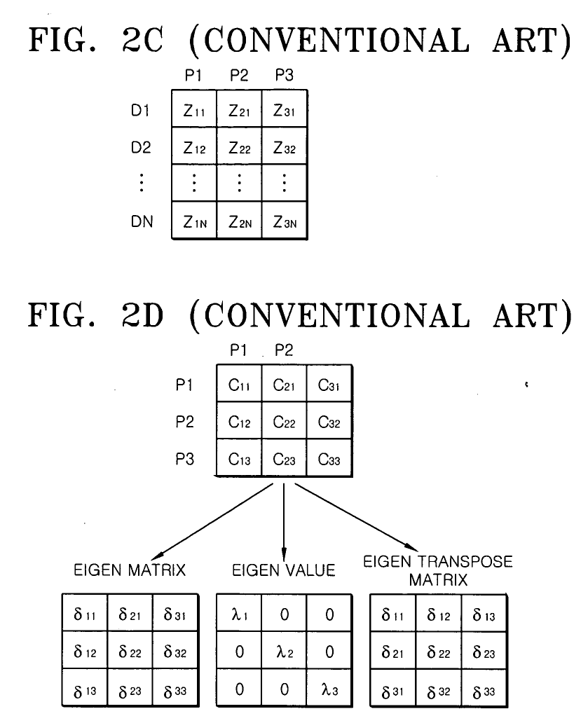

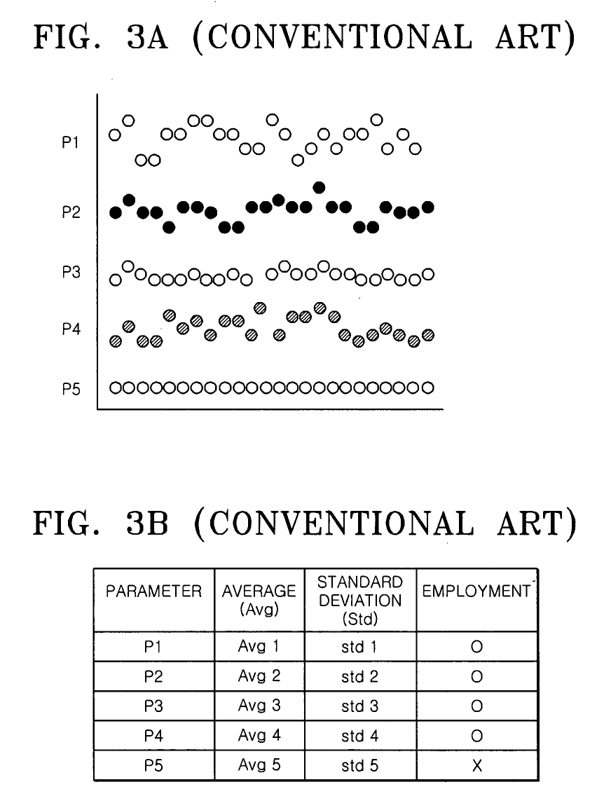

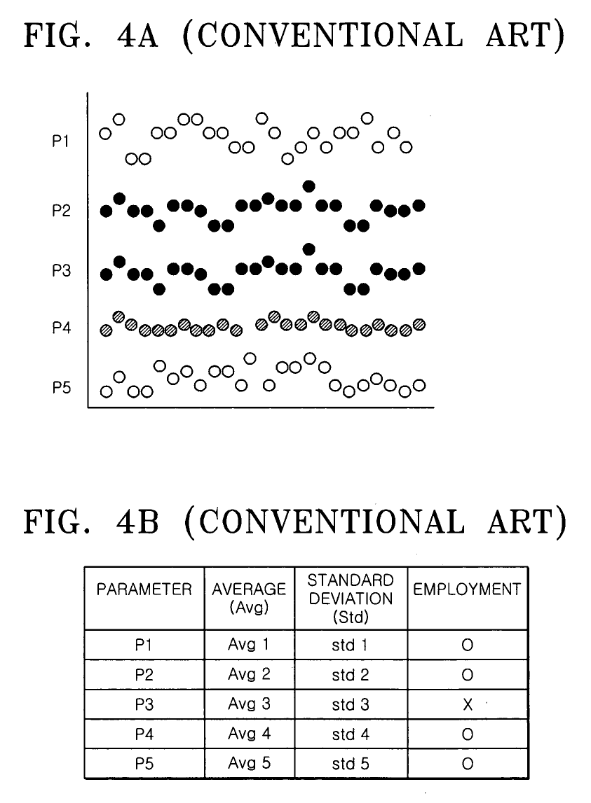

### DETAILED DESCRIPTION OF THE EXAMPLE EMBODIMENTS

Example embodiments of the present invention will now be described more fully with reference to the accompanying drawings, in which some example embodiments of the invention are shown. The invention may, however, be embodied in many alternate forms and should not be construed as being limited to only the embodiments set forth herein; rather, these embodiments are provided so that this disclosure will be thorough and complete, and will fully convey the concept of the invention to those skilled in the art.

Accordingly, while example embodiments of the invention are capable of various modifications and alternative forms, embodiments thereof are shown by way of example in the drawings and will herein be described in detail. It should be understood, however, that there is no intent to limit example embodiments of the invention to the particular forms disclosed, but on the contrary, example embodiments of the invention are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or” includes any and all combinations of one or more of the associated listed items.

The terminology used herein is for the purpose of describing particular embodiments only and is not intended to be limiting of example embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Example embodiments of the present invention relate to a multivariate modeling method, a method of fabricating semiconductors using a semiconductor fabricating facility and a multivariate model creating apparatus. Other example embodiments of the present invention relate to a method and apparatus for modeling multivariate parameters having constants and the same pattern and a semiconductor fabricating method of detecting whether a semiconductor fabricating facility is operating normally using the multivariate modeling method.

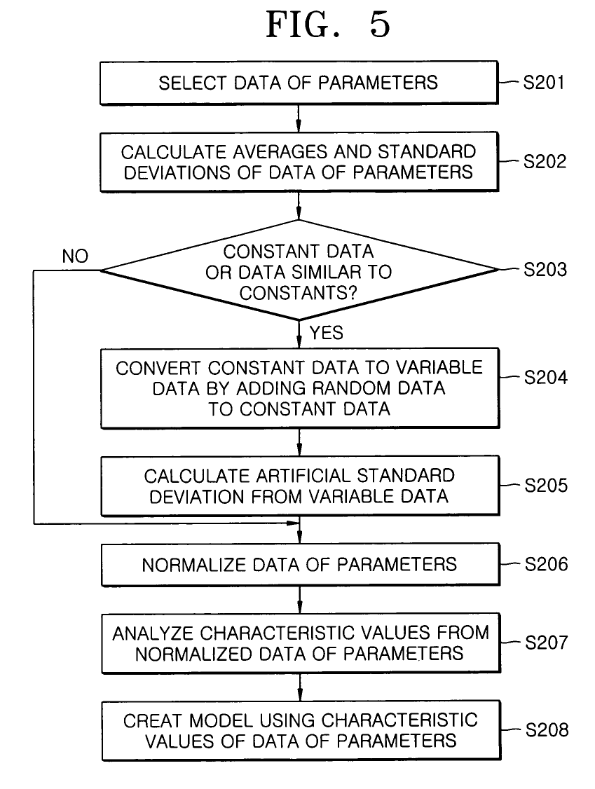

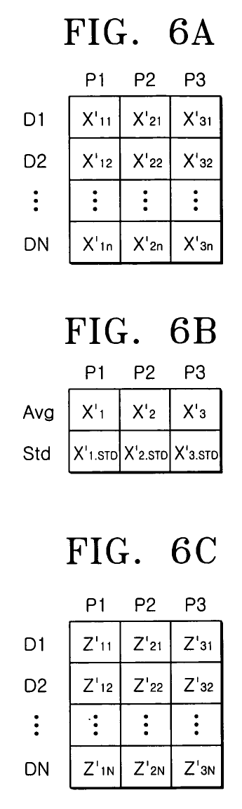

FIG. 5 is a flowchart illustrating a multivariate modeling method for parameters containing constant data according to example embodiments of the present invention. Referring to FIG. 5, in S201, the kinds of parameters for the multivariate modeling may be set and data of the set parameters may be selected. The data of the parameters may be selected by a user and sampled during a given period. The given period may be a modeling period and the selected data may have real numbers. The data may include various kinds of data for multivariate modeling, for example, process data, error detection data, financial data, gene data, data used for voice recognition, image data used for image recognition, and/or the like. In example embodiments of the present invention, three parameters P1, P2, and P3 may be selected and N data X11′ to X1n′, X21′ to X2n′, and X31′ to X3n′ of parameters P1, P2, and P3 may be selected. FIG. 6A illustrates a matrix representing parameters P1, P2, and P3 and the selected data D1 to DN. Though three parameters are selected to perform the multivariate modeling, example embodiments of the present invention may not be limited to this and according to a desired multivariate modeling method, parameters may be selected and data of each parameter may be variously sampled. The modeling period also may be determined.

In S202, basic statistical values may be obtained by calculating averages Avg and standard deviations Std of the data of parameters P1, P2, and P3. The averages Avg and the standard deviations Std may be estimated parameters obtained by conventional arithmetic calculation or statistical values obtained from samples. FIG. 6B illustrates a matrix representing the averages Avg and the standard deviations Std of parameters P1, P2, and P3. Parameter P1 may be the average Avg of x1′ and the standard deviation Std of x1STD′, parameter P2 may be the average Avg of x2′ and the standard deviation Std of x2STD′ and parameter P3 may be the average Avg of x3′ and the standard deviation Std of x3STD′.

After obtaining the averages Avg and the standard deviations Std in S202, it may be determined in S203 whether data of each parameter sampled in the modeling period contains non-random data (e.g., constants or data similar to constants). Each of parameters P1, P2, and P3 containing non-random data (e.g., constants or data similar to constants) may be determined using the standard deviations Std of parameters P1, P2, and P3 obtained in S202. The constant data may have constant values during the modeling period and the other period and the data similar to constants may have constant values only during the modeling period. If data of any one of parameters P1, P2, and P3 contains non-random data (e.g., constants or data similar to constants), a standard deviation Std of the data may be about 0. A parameter having constant data may be detected by determining whether the standard deviation Std of each of parameters P1, P2, and P3 may be about 0 in S203.

In S203, if it may be determined that parameters P1, P2, and P3 do not have non-random, or constant, data, the data may be normalized in S206 using the averages Avg and the standard deviations Std obtained in S202. If a parameter having non-random, or constant data, exists among parameters P1, P2, and P3, the constant data of the parameter may be converted to nonconstant data, e.g., variable data, by adding random data thereto in S204. In S205, a standard deviation of the parameter having the variable data in which the random data is added to the non-random, or constant data, may be obtained. Unlike the standard deviations Std obtained in S202, the standard deviation obtained in S205 may be a value obtained from artificial variable data in which the random data is added to the non-random, or constant data, and may be called an artificial standard deviation. The standard deviations Std of parameters P1, P2, and P3 obtained in S202 or S205 may be represented by a matrix illustrated in FIG. 6B.

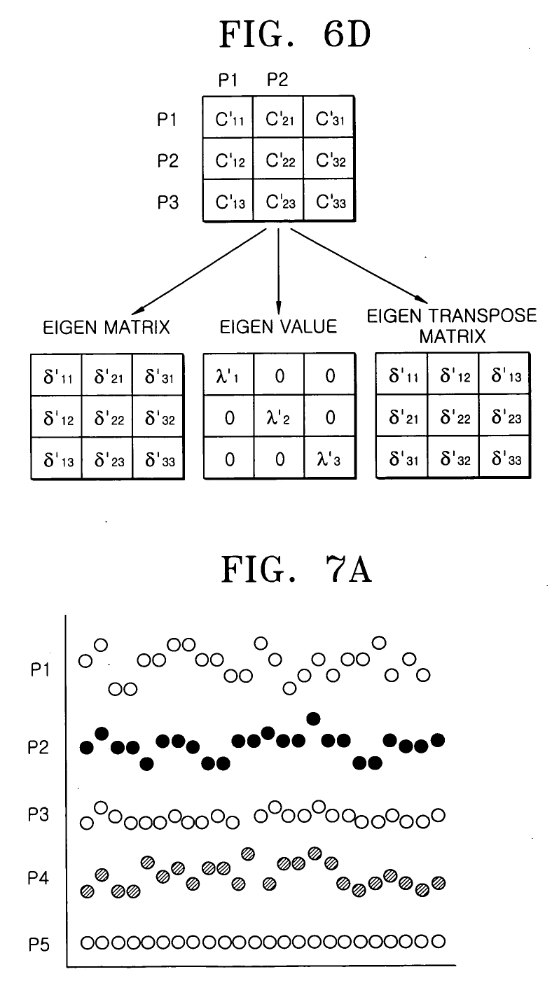

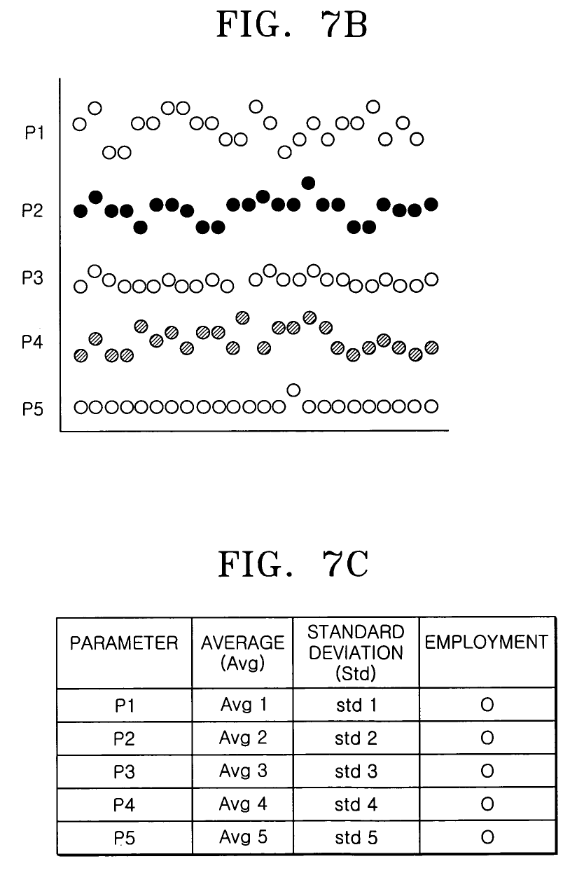

FIG. 7A illustrates data sampled of parameters P1 to P5 during a modeling period in which parameter P5 of parameters P1 to P5 may have non-random, or constant data. FIG. 7B illustrates that random data may be added to parameter P5 having non-random, or constant data, among parameters P1 to P5 sampled during the modeling period. Referring to FIG. 7A, parameter P5 of parameters P1 to P5 may have non-random, or constant data, without variation and a standard deviation std5 may be about 0. Parameter P5 may not then be applied to multivariate modeling.

If the data of parameter P5 is converted to nonconstant data, e.g., variable data, by adding random data to parameter P5 having the non-random data, or constant data, as illustrated in FIG. 7B, standard deviations std1 to std5 of parameters P1 to P5 may not be about 0 as illustrated in FIG. 7C and parameters P1 to P5 may be applied to the multivariate modeling. The random data added to the constant data may have a value within an acceptable range not affecting a contribution ratio, e.g., a value of an average Avg ±(0.001×Avg)=Avg ±0.1%. The value of the random data may vary according to characteristics of parameters. The contribution ratio indicates how much a certain parameter of parameters P1 to P5 affects the total variation of a semiconductor fabricating facility. Because the random data may be a kind of noise added to non-random data, or constant data, of a parameter for the multivariate modeling, it may be that the random data may have a value within an acceptable range not affecting the total variation. The standard deviation std5 of parameter P5 may not be about 0 when the parameter P5 has a standard deviation std5 of an artificial value with the addition of random data. Parameter P5 may be applied to multivariate modeling.

After obtaining the averages Avg and the standard deviations Std of the data of parameters P1 to P3 in S202 or S205, in S206, the data of parameters P1 to P3 may be normalized using the averages Avg and the standard deviations Std. The normalization may be performed by obtaining a difference between a current value and an average value and dividing the obtained difference by a standard deviation. The normalization may be performed to calculate the variation on standard data STD and to remove units between parameters P1 to P3 using the averages Avg and the standard deviations Std of the data of parameters P1 to P3 and derive a correlation matrix from a covariance matrix. If the units are removed between parameters P1 to P3, it may be easier to derive statistical amounts for calculating the total variation or perform data analysis (e.g., clustering analysis, classification analysis, and/or the like). FIG. 6C illustrates a matrix representing the normalized data Z11′ to Z1n′, Z21′ to Z2n′ and Z31′ to Z3n′ of parameters P1 to P3. The normalized data Z11′ to Z1n′, Z21′ to Z2n′ and Z31′ to Z3n′ of parameters P1 to P3 may have constants from which units are removed.

In S207, characteristic values of parameters P1 to P3 may be analyzed using the normalized data Z11′ to Z1n′, Z21′ to Z2n′ and Z31′ to Z3n′ of parameters P1 to P3. Correlations between parameters P1 to P3 may be derived by obtaining a covariance matrix from the normalized data Z11′ to Z1n′, Z21′ to Z2n′ and Z31′ to Z3n′ and obtaining an eigen matrix, an eigen value, and an eigen transpose matrix from the covariance matrix. FIG. 6D illustrates the covariance matrix, which may be obtained from the normalized data Z11′ to Z1n′, Z21′ to Z2n′, and Z31′ to Z3n′ of parameters P1 to P3 and the eigen matrix, the eigen value, and the eigen transpose matrix which may be obtained from the covariance matrix. In s208, a desired model may be created using the analyzed characteristic values of parameters P1 to P3.

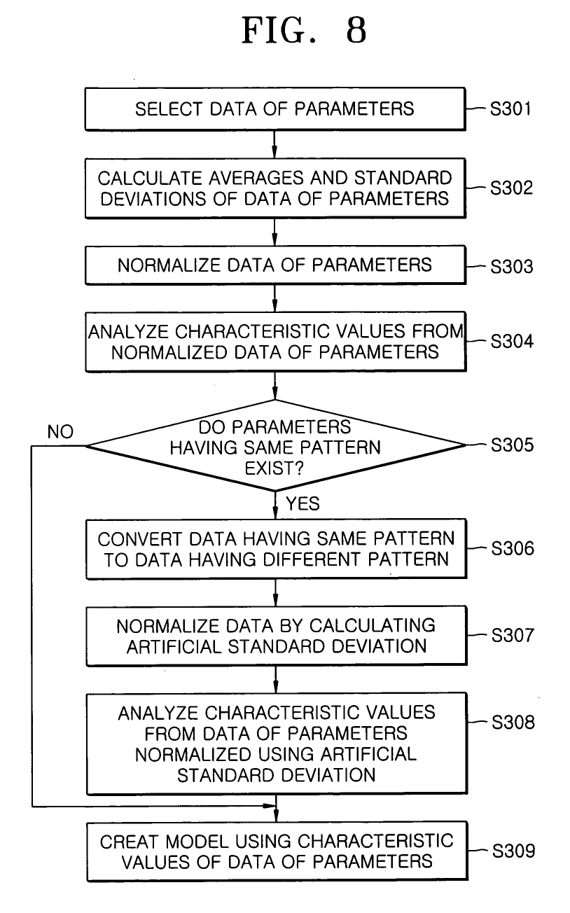

FIG. 8 is a flowchart of a multivariate modeling method for parameters containing constant data according to other example embodiments of the present invention. Referring to FIG. 8, in S301, parameters for the multivariate modeling may be set and data of the set parameters may be selected. The data of the parameters may be selected by a user and sampled during a given period. The given period may be a modeling period and the selected data may have real numbers. In example embodiments of the present invention, three parameters P1, P2, and P3 may be selected and N data X11′ to X1n′, X21′ to X2n′ and X31′ to X3n′ of parameters P1, P2, and P3 may be selected. A matrix representing parameters P1, P2, and P3 and the selected data D1 to DN may be the same as that illustrated in FIG. 6A. Though three parameters may be selected to perform multivariate modeling, example embodiments of the present invention may not be limited to this, and according to a desired multivariate modeling method, parameters may be selected and data of each parameter may be sampled in various manners. The modeling period also may be determined at will.

In S302, basic statistical values may be obtained by calculating averages Avg and standard deviations Std of the data of parameters P1, P2, and P3. A method of obtaining the averages Avg and the standard deviations Std may be the same as that of example embodiments of the present invention and a matrix representing the obtained averages Avg and standard deviations Std may be the same as that illustrated in FIG. 6B. Parameter P1 may have the average Avg of x1′ and the standard deviation Std of x1STD′, parameter P2 may have the average Avg of x2′ and the standard deviation Std of x2STD′ and parameter P3 may have the average Avg of x3′ and the standard deviation Std of x3STD′.

After obtaining the averages Avg and the standard deviations Std of the data of parameters P1 to P3 in S302, in S303, the data of parameters P1 to P3 may be normalized. A matrix representing the normalized data may be the same as that illustrated in FIG. 6C. After obtaining the normalized data in S303, in S304, characteristic values of parameters P1 to P3 may be analyzed using the normalized data. A covariance matrix, an eigen matrix, an eigen value, and/or the like, which may be obtained from the normalized data, may be the same as the matrices illustrated in FIG. 6D.

In S305, it may be determined whether parameters having the same pattern exist among parameters P1 to P3 using the characteristic values analyzed in S304. It may be determined whether parameters having non-random data, or the same pattern, exist using the characteristic values of parameters P1 to P3 obtained in S304. It may be determined whether parameters having the same pattern exist using the eigen matrix obtained from the covariance matrix and if any eigen vectors obtained from the eigen matrix are the same, it may be determined that parameters having non-random data, or the same pattern, exist. If parameters having non-random data, or the same pattern, do not exist as a result of the determination in S305, in S309, a model may be created using the characteristic values of parameters P1 to P3 obtained in S304. If parameters having non-random data, or the same pattern, exist as a result of the determination in S305, in S306, random data may be added to an arbitrary parameter of the parameters having the same pattern so that parameters P1 to P3 may have different data.

After changing data of the arbitrary parameter by adding the random data to the arbitrary parameter, in S307, an artificial standard deviation of changed data may be obtained and data of parameters P1 to P3 including the parameters having the same pattern may be normalized using the artificial standard deviation. In S308, characteristic values of parameters P1 to P3 may be analyzed again as illustrated in FIG. 6D using the data normalized in S307 based on the artificial standard deviation. In S309, a model may be created using the characteristic values of parameters P1 to P3.

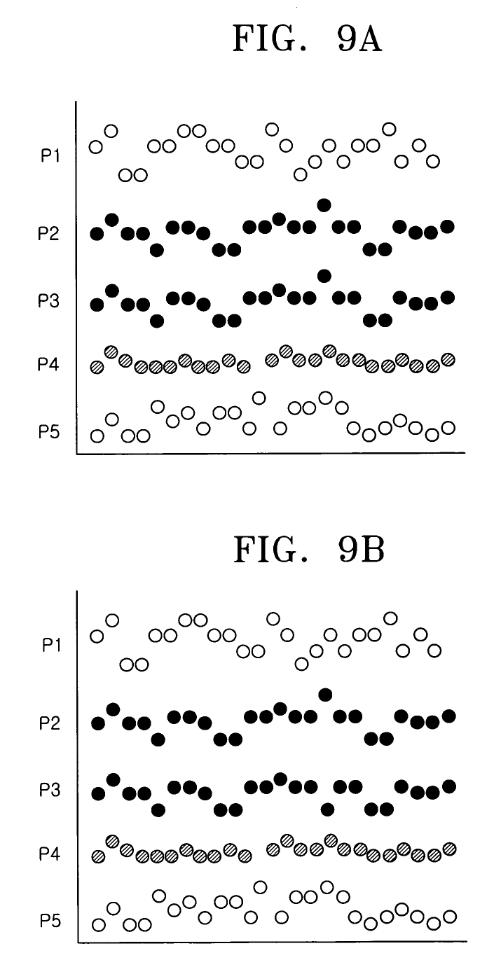

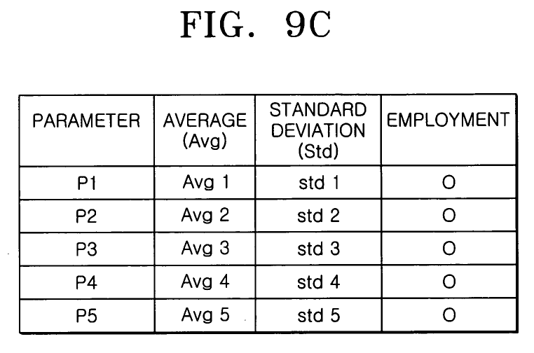

FIG. 9A illustrates data of parameters P1 to P5 including parameters having non-random data, or the same pattern, sampled during the modeling period. FIG. 9B illustrates data of parameters P1 to P5 having data to which a random number may be added during the modeling period. Referring to FIG. 9A, because parameters P2 and P3 of parameters P1 to P5 may have non-random data, or the same pattern, their eigen vectors may be about 0. One of parameters P2 and P3 may not be applied to multivariate modeling. Referring to FIG. 9B, random data may be added to one of parameters P2 and P3 having the same pattern, for instance, parameter P3. The random data may have a value within an acceptable range not affecting a contribution ratio and it may be that the random data may have a value of an average Avg about ±0.1%. The random data may vary according to parameters. The eigen matrix may have non-zero values by obtaining an artificial standard deviation by addition of the random data to parameter P3 and normalizing the data of parameters P1 to P5 using the obtained artificial standard deviation. Parameter P3 may be applied to multivariate modeling because the eigen matrix is not about 0 as illustrated in FIG. 9C.

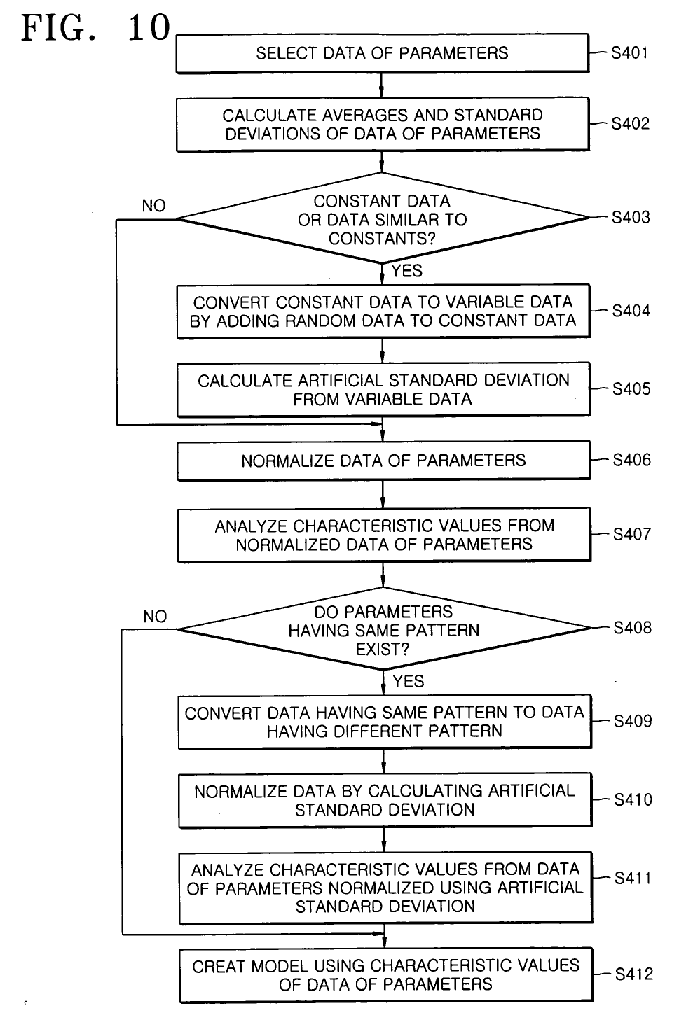

FIG. 10 is a flowchart of a multivariate modeling method according to example embodiments of the present invention. Referring to FIG. 10, in S401, the kinds of parameters for the multivariate modeling may be set, and data of the set parameters may be selected. The data of parameters P1, P2, and P3 may be selected by a user and sampled during a given period. The given period may be a modeling period, and the selected data may have real numbers. Though three parameters are selected to perform the multivariate modeling, example embodiments of the present invention may not be limited to this, and according to a desired multivariate modeling method, parameters may be selected and data of each parameter may be sampled in various manners. The modeling period also may be determined at will. A matrix representing the data of parameters P1, P2, and P3 may be the same as that illustrated in FIG. 6A.

In S402, basic statistical values may be obtained by calculating averages Avg and standard deviations Std of parameters P1, P2, and P3. A matrix representing the averages Avg and the standard deviations Std of parameters P1, P2, and P3 may be the same as that illustrated in FIG. 6B. In S403, it may be determined whether data of each parameter sampled in the modeling period contain non-random data (e.g., constants or data similar to constants) using the standard deviations Std obtained in S402. As the determination result in S403, if it is determined that parameters P1, P2, and P3 may not have non-random, or constant data, in S406, the data may be normalized using the averages Avg and the standard deviations Std obtained in S402.

If a parameter having constant data exists among parameters P1, P2, and P3, in S404, the constant data of the parameter may be converted to nonconstant data, e.g., variable data, by adding random data thereto. The random data may have a value of Avg±0.1% and may vary according to parameters. After converting the constant data to variable data, in S405, an artificial standard deviation of the parameter having the variable data in which the random data may be added to the non-random data, or constant data, is obtained. A method of obtaining the averages Avg and the standard deviations Std may be the same as that of example embodiments of the present invention. A matrix representing the obtained averages Avg and standard deviations Std may be the same as that illustrated in FIG. 6B. In S406, the data of parameters P1 to P3 may be normalized using the artificial standard deviation of the parameter obtained in S405. A matrix representing the normalized data may be the same as that illustrated in FIG. 6C. In S407, characteristic values of parameters P1 to P3 may be analyzed using the normalized data of parameters P1 to P3 obtained in S406. A covariance matrix, an eigen matrix, an eigen value, and/or the like, which are obtained from the normalized data in S407, may be the same as the matrices illustrated in FIG. 6D.

In S408, it may be determined whether parameters having non-random data, or the same pattern, exist among parameters P1 to P3 using the characteristic values analyzed in S407. It may be determined whether parameters having non-random data, or the same pattern, exist using the characteristic values of parameters P1 to P3 obtained in S407. If any obtained eigen vector is about 0, it may be determined that parameters having non-random data, or the same pattern, exist. If parameters having non-random data, or the same pattern, do not exist as a result of the determination in S408, in S412, a model may be created using the characteristic values of parameters P1 to P3 obtained in S407. If parameters having non-random data, or the same pattern, exist as a result of the determination in S408, in S409, random data may be added to an arbitrary parameter of the parameters having the same pattern so that parameters P1 to P3 may have different data. The random data may have a value of Avg±0.1%.

After changing data of the arbitrary parameter by adding the random data to the arbitrary parameter among the parameters having non-random data, or the same pattern, in S410, an artificial standard deviation of the changed data may be obtained and data of parameters P1 to P3 including the parameters having the same pattern may be normalized using the artificial standard deviation. In S411, characteristic values of parameters P1 to P3 may be analyzed again as illustrated in FIG. 6D using the data normalized in S410. In S412, a model may be created using the characteristic values of parameters P1 to P3.

The multivariate modeling methods may be applied to a semiconductor fabricating process, a fingerprint or image recognition field, a financial field, and/or the like. Any of the multivariate modeling methods may be applied to detect whether a semiconductor fabricating facility normally operates in the semiconductor fabricating process. According to a method of detecting whether a semiconductor fabricating facility operates normally using one of the multivariate modeling methods, a model may be created by performing multivariate modeling on process parameters for the semiconductor fabricating process using one of the multivariate modeling methods. It may be detected whether the semiconductor fabricating facility normally operates by comparing the created model to actual process parameters provided to the semiconductor fabricating facility during the semiconductor fabricating process. If the semiconductor fabricating facility does not operate normally, the semiconductor fabricating process may be stopped. The semiconductor fabricating facility may include a diffusion device, a photo device, an etching device, a sputter device, a chemical vapor deposition (CVD) device, an ion-implanting device, a chemically-mechanically polishing (CMP) device, a cleaning device and/or any other suitable device.

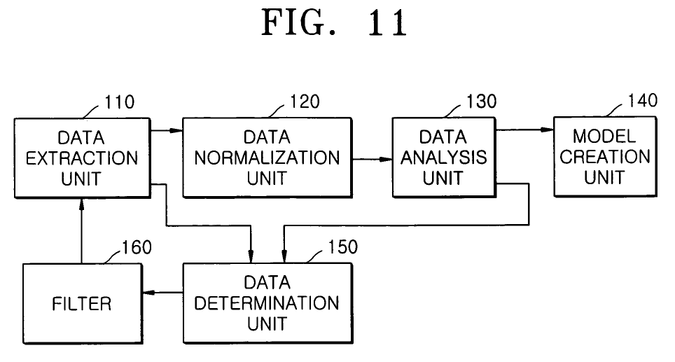

FIG. 11 is a block diagram illustrating a multivariate model creating apparatus for implementing a multivariate modeling method according to example embodiments of the present invention. Referring to FIG. 11, a multivariate model creating apparatus may include a data extraction unit 110, a data normalization unit 120, a data analysis unit 130, a model creation unit 140, a data determination unit 150 and a filter 160. The data extraction unit 110 may select data of parameters and may calculate averages Avg and standard deviations Std of the selected data. The data normalization unit 120 may normalize the data of the parameters using the averages Avg and the standard deviations Std provided by the data extraction unit 110. The data analysis unit 130 may analyze characteristic values of the parameters using the normalized data provided by the data normalization unit 120. The model creation unit 140 may create a model based on the characteristic values of the parameters analyzed by the data analysis unit 130.

The data determination unit 150 may determine whether each parameter contains non-random data, or constant data, using the standard deviations Std calculated by the data extraction unit 110 or whether parameters may have the same pattern using eigen vectors provided by the data analysis unit 140. The filter 160 may provide random data to the data extraction unit 110 if it may be determined by the data determination unit 150 that the parameters contain non-random data (e.g., constants or data similar to constants or may have the same pattern). The random data may have a value within a range of an average Avg of the parameters obtained by the data extraction unit 110 at about ±0.1%. The value of the random data may vary according to parameters used in a semiconductor fabricating process. If the random data is provided from the filter 160, the data extraction unit 110 may obtain an artificial standard deviation based on the random data and may provide the artificial standard deviation to the data normalization unit 120. The data normalization unit 120 may normalize the data of the parameters based on the artificial standard deviation. According to example embodiments of the present invention, hardware for implementing a multivariate modeling method may not be limited to the configuration illustrated in FIG. 11 and may have various configurations.

As described above, according to example embodiments of the present invention, by adding a random number to non-random data (e.g., constants or data similar to constants or to one of data having the same pattern), multivariate modeling may be performed and correct modeling for a plurality of parameters may be performed. According to example embodiments of the present invention, by using multivariate modeling methods not only in a semiconductor fabricating process, but also in image processing, fingerprint recognition, face recognition field and/or the like, even if non-random data exists, multivariate modeling may be performed correctly.

While example embodiments of the present invention may have been particularly shown and described with reference to the example embodiments thereof, it will be understood by those of ordinary skill in the art that various changes in form and detail may be made therein without departing from the spirit and scope of the present invention as defined by the following claims.

What is claimed is:

1. A multivariate modeling method comprising:
selecting data of parameters during a modeling period;
calculating averages and standard deviations of the data of the parameters;
determining whether the data of the parameters contains non-random data;
if the data of the parameters contain non-random data as the determination result, adding random data to data of a parameter containing the non-random data among the parameters;
normalizing the data by calculating an artificial standard deviation of the random data added data of the parameter;
analyzing characteristic values of the parameters from the normalized data; and
creating a model based on the characteristic values.

2. The method of claim 1, wherein whether the data of the parameters contain non-random data is determined by determining whether each standard deviation of the data of the parameters is 0.

3. The method of claim 1, wherein the non-random data is constants or data of the parameters similar to constants.

4. The method of claim 1, wherein the non-random data is data of the parameters having the same pattern.

5. The method of claim 1, wherein if the data of the parameters do not contain non-random data as the determination result, normalizing the data using the averages and standard deviations of the data of the parameters.

6. The method of claim 3, wherein the constant data have constant values without variation and the data similar to constants have constant values without variation during the modeling period.

7. The method of claim 1, wherein the random data has a value of the average±0.1% of the data of the parameters.

8. The method of claim 1, wherein the model is created using one of a principal component analysis (PCA) method, an independent component analysis (ICA) method, and a partial least squares (PLS) method.

9. The method of claim 1, wherein whether the data of the parameters have the non-random data is determined by determining whether any eigen vector of the data of the parameters is about 0.

10. The method of claim 1, wherein after calculating averages and standard deviations of the data of the parameters, normalizing the data using the averages and the standard deviations of the parameters and analyzing characteristic values of the parameters from the normalized data of the parameters.

11. The method of claim 10, wherein if the data of the parameters does not contain non-random data as the determination result, creating a model based on the characteristic values of the parameters.

12. The method of claim 1, wherein determining includes:
(a) determining whether the data of the parameters contain constants or data similar to constants;
(b) if the data of the parameters do not contain constants or data similar to constants as the determination result, normalizing the data using the averages and standard deviations of the data of the parameters;
(c) if the data of the parameters contain constants or data similar to constants as the determination result, adding random data to data of a parameter containing the constants or the data similar to constants among the parameters;
(d) normalizing the data by calculating an artificial standard deviation of the random data added data of the parameter;
(e) analyzing characteristic values of the parameters from the data normalized in operation (d) or (f);
(f) determining whether parameters having the same pattern exist using the characteristic values of the parameters;
(g) if parameters having the same pattern do not exist as the result determined in operation (h), creating a model based on the characteristic values of the parameters;
(j) if parameters having the same pattern exist as the result determined in operation (h), adding random data to an arbitrary parameter of the parameters having the same pattern;

13. A method of fabricating semiconductors including the multivariate modeling method of claim 1.

14. A method according to claim 13, wherein whether the semiconductor fabricating facility is operating normally can be determined by comparing the created model to actual data input to the semiconductor fabricating facility; and
if the semiconductor fabricating facility is not operating normally, stopping an operation of the semiconductor fabricating process.

15. The method of claim 13, wherein the determination of whether the data contains non-random data includes:
calculating averages and standard deviations of the data of the process parameters; and
determining whether the data of the process parameters are constant data using the standard deviations.

16. The method of claim 13, wherein the determination of whether the data contains non-random data includes:
calculating averages and standard deviations of the data of the process parameters;
normalizing the data using the averages and the standard deviations of the data;
analyzing characteristic values of the parameters from the normalized data; and
determining whether parameters having the same pattern exist using Eigen vectors the characteristic values of the parameters.

17. A multivariate model creating apparatus comprising:
a data extraction unit selecting data of parameters and calculating averages and standard deviations of the selected data;
a data normalization unit normalizing the data of the parameters using the averages and the standard deviations provided by the data extraction unit;
a data analysis unit analyzing characteristic values of the parameters using the normalized data provided by the data normalization unit;
a model creation unit creating a model based on the characteristic values of the parameters analyzed by the data analysis unit;
a data determination unit determining whether each parameter contains constant data using the standard deviations calculated by the data extraction unit or whether parameters have the same pattern using eigen vectors provided by the data analysis unit; and
a filter providing random data to the data extraction unit if it is determined by the data determination unit that the parameters contain constants or data similar to constants or have the same pattern.
